(19) United States
(12) Patent Application Publication
(10) Pub. No.: US 2025/0353016 A1
(43) Pub. Date: Nov. 20, 2025

(54) APPARATUS AND METHOD FOR REDUCING OXIDATION OF REAGENTS IN A REAGENT CARTRIDGE

(71) Applicant: ILLUMINA, INC., San Diego, CA (US)

(72) Inventors: Zhishan Hua, San Diego, CA (US); Emerico Brewer, San Diego, CA (US); Robert Jenkins, San Diego, CA (US); Stephanie Ogrey, Fremont, CA (US)

(21) Appl. No.: 18/876,600

(22) PCT Filed: Mar. 26, 2024
(86) PCT No.: PCT/US2024/021410

§ 371 Date: Dec. 18, 2024

Related U.S. Application Data
(60) Provisional application No. 63/456,074, filed on Mar. 31, 2023.

(51) Int. Cl. B01L 3/00

(52) U.S. Cl. CPC B01L 3/523; B01L 3/502; B01L 3/527; B01L 2200/025; B01L 2400/0487

(57) ABSTRACT

Apparatus and methods for reducing oxidation of reagents in a reagent cartridge are disclosed. In according with an implementation, an apparatus includes a reagent cartridge comprising a plurality of side walls and an end wall that form a well. A reagent is disposed within the well and a floating lid is disposed in the well on a top surface of the reagent. The floating lid covers a majority of the top surface of the reagent.

### RELATED APPLICATION

This application claims the benefit of and priority to U.S. Provisional Patent Application No. 63/456,074, filed Mar. 31, 2023, the content of which is incorporated by reference herein in its entireties and for all purposes.

### BACKGROUND

Reducing or preventing oxidation of reagents that are stored/transported in and delivered from reagent cartridges can be a challenge. In many processes, reagents are stored/transported in and delivered from a reagent cartridge having a cover or sealed foil positioned over the well containing the reagent to reduce or prevent the oxidation of the reagent with the cartridge.

### SUMMARY

Advantages and benefits over the prior art as described later in this disclosure can be achieved through the provision of apparatus, reagent cartridges, and methods for reducing oxidation of reagents in a reagent cartridge. Various implementations of the apparatus, reagent cartridges, and methods are described below, and the apparatus, reagent cartridges, and methods, including and excluding the additional implementations enumerated below, in any combination (provided these combinations are not inconsistent), may overcome these shortcomings and achieve the benefits described herein.

In accordance with a first implementation, an apparatus comprises a reagent cartridge comprising a plurality of side walls and an end wall that form a well. A reagent is disposed within the well and a floating lid is disposed in the well on a top surface of the reagent. The floating lid covers a majority of the top surface of the reagent.

In accordance with a second implementation, an apparatus comprises a reagent cartridge comprising a plurality of side walls and an end wall that form a well. A reagent is disposed within the well and a plurality of plastic pellets are disposed in the well on a top surface of the reagent. The plurality of plastic pellets cover a majority of the top surface of the reagent.

In accordance with a third implementation, an apparatus comprises a reagent cartridge comprising a plurality of side walls and an end wall that form a well. A reagent is disposed within the well and an oil is disposed in the well on a top surface of the reagent. The oil covers the top surface of the reagent.

In accordance with a fourth implementation, a reagent cartridge comprises a main body comprising an end wall and a plurality of side walls extending from the end wall, the end wall and the plurality of side walls forming a plurality of wells. An opening extends through the end wall and into one well of the plurality of wells. A floating lid is disposed in the one well of the plurality of wells and a cover is positioned on the main body and covers at least a portion of the plurality of wells.

In accordance with a fifth implementation, a method comprises: filling at least a portion of a well of a reagent cartridge with a reagent, the reagent cartridge comprising a plurality of side walls and an end wall that form a well; and positioning a floating lid within the well on a top surface of the reagent such that the floating lid covers a majority of the top surface of the reagent.

In accordance with a sixth implementation, an apparatus includes a body and a lid. The body includes a plurality of side walls and a bottom surface that form a reagent reservoir. The bottom surface includes a port. The lid is movably disposed in the reagent reservoir and includes protrusions that extend toward the bottom surface. The protrusions are to engage the bottom surface to deter the lid from inhibiting fluid flow through the port.

In accordance with a seventh implementation, an apparatus includes a body and a lid. The body includes a plurality of side walls and a bottom surface that form a reagent reservoir. The lid is movably disposed in the reagent reservoir.

In accordance with an eighth implementation, a method of nucleic acid sequencing using the apparatus of any of implementations 1-4 or 6-7 comprises: withdrawing a first portion of the reagent from the well at a first time; and withdrawing a second portion of the reagent from the well at a second time, the second time being at least 36 hours after the first time, with no reduction in the reagent chemistry.

In accordance with a nineth implementation, an apparatus includes a reagent cartridge comprising a well, a reagent disposed within the well, and a cover disposed in the well.

In further accordance with the foregoing first, second, third, fourth, fifth, sixth, seventh, eighth, and/or nineth implementations, an apparatus, reagent cartridge, and/or method may further include or comprise any one or more of the following:

In an implementation, a top surface of the floating lid is convex.

In another implementation, the floating lid comprises a first plurality of protrusions located at positions around a circumference of the floating lid and extending from a bottom surface of the floating lid.

In another implementation, the floating lid comprises a second plurality of protrusions located at positions around the circumference of the floating lid and extending from a top surface of the floating lid.

In another implementation, the first plurality of protrusions are axially aligned with the second plurality of protrusions.

In another implementation, the floating lid comprises at least one aperture formed through the floating lid and configured to receive at least one of a sipper, a wash tube, and/or an additional reagent container.

In another implementation, the apparatus comprises a post having an outer shape, the post configured to be positioned with the well generally parallel to the side walls and the floating lid includes a guide aperture having a shape generally the same as the outer shape of the post. The floating lid is disposed in the well with the post extending through the guide aperture.

In another implementation, the apparatus comprises a support positioned at an end of the post, the support having at least two legs extending towards and to respective side walls.

In another implementation, the post and the support form an integral, one-piece unit.

In another implementation, the plurality of plastic pellets each have at least one of a cuboid shape, an ovoid shape, a cylindrical shape, or a spheroid shape.

In another implementation, the plurality of plastic pellets each have a maximum axial length of between about 3.0 to about 4.0 mm.

In another implementation, the plurality of plastic pellets each have a maximum axial length of less than about 1.5 mm.

In another implementation, the oil is one of a mineral oil or a silicone oil.

In another implementation, the method comprises positioning a post within the well generally parallel to the side walls, the post having an outer shape; and positioning the floating lid within the well such that the post extends through a guide aperture in the floating lid.

In another implementation, the apparatus includes reagent disposed in the reagent reservoir.

In another implementation, the reagent includes liquid reagent.

In another implementation, the reagent includes dried reagent.

In another implementation, each of the protrusions have an exterior facing surface that engages or interacts with the side walls.

In another implementation, the exterior facing surface corresponds to the side walls.

In another implementation, the exterior facing surfaces have flat portions.

In another implementation, the lid comprises second protrusions that extend away from the bottom surface.

In another implementation, each of the second protrusions have an exterior facing surface that engages the side walls.

In another implementation, an interaction between the second protrusions and the side walls deter the lid from rotating within the reagent reservoir.

In another implementation, a length of the protrusions and the second protrusions are similar or the same.

In another implementation, a length of the protrusions is less than a length of the second protrusions.

In another implementation, one or more of the protrusions or the second protrusions have a semi-circular cross section.

In another implementation, the reagent reservoir has an opening, further comprising a liquid impermeable barrier covering the opening of the reagent reservoir.

In another implementation, the liquid impermeable barrier comprises foil or a thin plastic sheet.

In another implementation, the apparatus includes a cover covering the liquid impermeable barrier and coupled to the body.

In another implementation, the cover comprises an aperture to allow the liquid impermeable barrier to be accessed through the aperture.

In another implementation, the lid is to enable temperature control of reagent within the reagent reservoir.

In another implementation, the second time is at least 10 days after the first time. In another implementation, the second time is at least 15 days after the first time.

In another implementation, the cover comprises a floating lid disposed in the well on a top surface of the reagent, the floating lid covering a majority of the top surface of the reagent.

In another implementation, the cover comprises an oil disposed in the well on a top surface of the reagent, the oil covering the top surface of the reagent.

In another implementation, the cover comprises a plurality of plastic pellets disposed in the well on a top surface of the reagent, the plurality of plastic pellets covering a majority of the top surface of the reagent.

In another implementation, the cover comprises a plurality of pellets disposed in the well on a top surface of the reagent, the plurality of pellets covering a majority of the top surface of the reagent.

It should be appreciated that all combinations of the foregoing concepts and additional concepts discussed in greater detail below (provided such concepts are not mutually inconsistent) are contemplated as being part of the subject matter disclosed herein and/or may be combined to achieve the particular benefits of a particular aspect. In particular, all combinations of claimed subject matter appearing at the end of this disclosure are contemplated as being part of the subject matter disclosed herein.

### BRIEF DESCRIPTION OF THE DRAWINGS

FIG. 1 illustrates a perspective view of a first implementation of an apparatus for reducing oxidation of reagents in a reagent cartridge;

FIG. 2 illustrates a perspective view of the apparatus of FIG. 1 with the cover removed;

FIG. 3 illustrates a cross-sectional view of the apparatus of FIG. 1, taken along line A-A in FIG. 1;

FIG. 4 illustrates a perspective view of the floating lid of the apparatus of FIG. 1;

FIG. 5 illustrates a perspective view of a second implementation of an apparatus for reducing oxidation of reagents in a reagent cartridge;

FIG. 6 illustrates a cross-sectional view of the apparatus of FIG. 5, taken along line B-B of FIG. 5;

FIG. 7 illustrates a perspective view of the floating lid, post, and support of the apparatus of FIG. 5;

FIG. 8 illustrates a perspective view of a third implementation of an apparatus for reducing oxidation of reagents in a reagent cartridge;

FIG. 9 illustrates a cross-sectional view of the apparatus of FIG. 8, taken along line C-C of FIG. 8;

FIG. 10 illustrates a cross-sectional view of the apparatus of FIG. 8, taken along line D-D of FIG. 8;

FIG. 11 illustrates a perspective view of the floating lid of the apparatus of FIG. 8;

FIG. 12 illustrates a perspective view of a fourth implementation of an apparatus for reducing oxidation of reagents in a reagent cartridge;

FIG. 13 illustrates a perspective view of the apparatus of FIG. 12 with the cover removed;

FIG. 14 illustrates a top perspective view of the floating lid of the apparatus of FIG. 12;

FIG. 15 illustrates a bottom perspective view of the floating lid of the apparatus of FIG. 12;

FIG. 16 illustrates a perspective view of a fifth implementation of an apparatus for reducing oxidation of reagents in a reagent cartridge;

FIG. 17 illustrates a perspective view of the apparatus of claim 16 with the cover removed;

FIG. 18 illustrates a cross-sectional view of the apparatus of claim 16, taken along line E-E of FIG. 16;

FIG. 19 illustrates a perspective view of a sixth implementation of an apparatus for reducing oxidation of reagents in a reagent cartridge;

FIG. 20 illustrates a perspective view of the apparatus of FIG. 19 with the cover removed;

FIG. 21 illustrates a cross-sectional view of the apparatus of FIG. 19, taken along line F-F of FIG. 19;

FIG. 22 illustrates a first implementation of a method for reducing oxidation of reagents in a reagent cartridge; and

FIG. 23 illustrates a schematic diagram of an implementation of a system in accordance with the teachings of this disclosure.

### DETAILED DESCRIPTION

Although the following text discloses a detailed description of implementations of methods, apparatuses, and/or articles of manufacture, it should be understood that the legal scope of the property right is defined by the words of the claims set forth at the end of this patent. Accordingly, the following detailed description is to be construed as examples only and does not describe every possible implementation, as describing every possible implementation would be impractical, if not impossible. Numerous alternative implementations can be implemented, using either current technology or technology developed after the filing date of this patent. It is envisioned that such alternative implementations would still fall within the scope of the claims.

In many processes, reagents are stored/transported in and delivered from a reagent cartridge having a cover or sealed foil positioned over the well containing the reagent to reduce or prevent the oxidation of the reagent with the cartridge. However, the ability to reduce or prevent oxidation of the reagent is greatly diminished if the cover is removed, if the cover does not provide a sufficient air-tight seal, if there is oxygen in the well when the cover is applied, or after a sealed foil is punctured.

In general, the rate of oxygen diffusion into reagents is proportional to: the percentage of oxygen in the headspace above the reagent in the well; the exposed reagent surface area; and the oxygen and reagent diffusion coefficient.

At least one aspect of this disclosure is directed toward apparatus, reagent cartridges, and methods for reducing the oxidation of a reagent in a reagent cartridge. In at least one aspect of this disclosure, one or more engineering control agents (such as a floating lid, plastic pellets, or oil) are added to the reagent well on a top surface of the reagent to cover a majority of the reagent. These engineering control agents reduce the rate of oxygen diffusion from the headspace in the well into the reagent by reducing the surface area of the reagent that is exposed to oxygen.

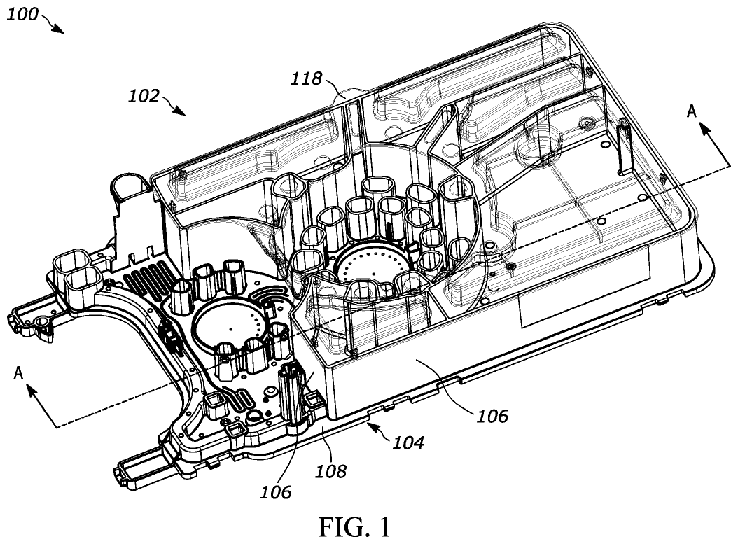

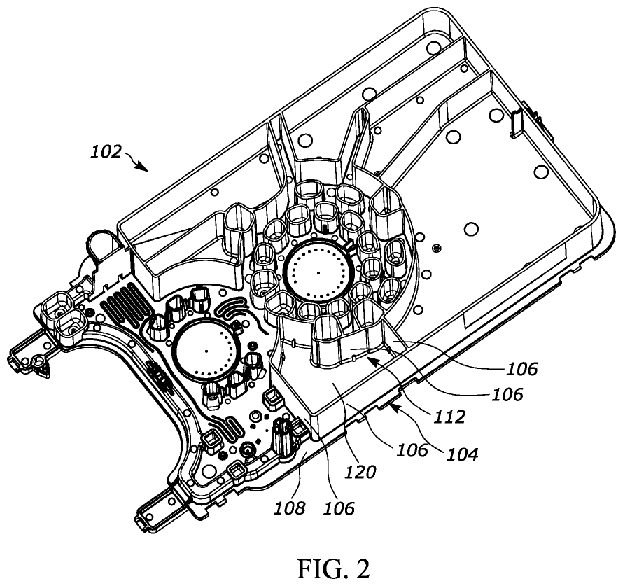

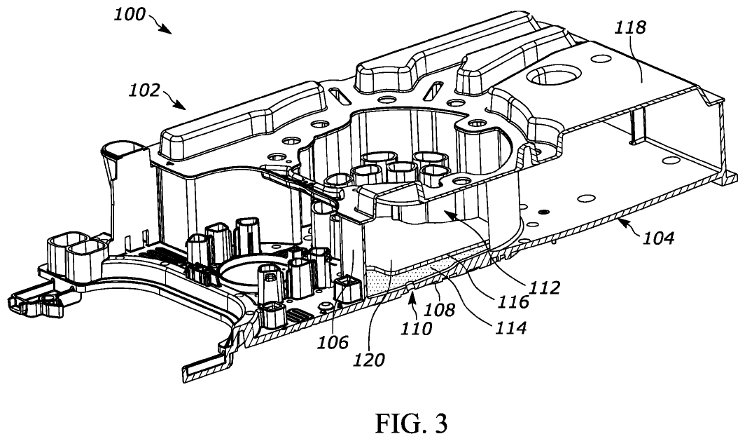

FIGS. 1-4 illustrate a first implementation of an apparatus 100 that can be used for reducing oxidation of reagents in a reagent cartridge. In this implementation, apparatus 100 includes a reagent cartridge 102 having a main body 104 with an end wall 108, or bottom, and a plurality of side walls 106 extending from end wall 108. Side walls 106 and end wall 108 of main body 104 can form a well 112, or a plurality of wells, depending on the design and use of reagent cartridge 102. A reagent 114 can be disposed in well 112 and an opening 110 can be formed in end wall 108, in fluid communication with well 112, and extend through end wall 108 and into well 112 to extract reagent 114 from well 112 during operation. The opening 110 may be referred to as a port. The reagent 114 may be liquid reagent or a dried reagent. The reagent 114 may alternatively be omitted from the well 112 and/or added at a later time. A floating lid 120 can also be disposed in well 112 on a top surface 116 of reagent 114 to reduce oxidation of reagent 114 and, in some instances, assist in temperature control of reagent 114. For example, the floating lid 120 may allow the reagent 114 to remain at a threshold temperature.

Floating lid 120 can be made of any suitable material, such as polypropylene, such that floating lid 120 will float on top surface 116 of reagent 114, cover a majority of top surface 116 of reagent 114, and the gap formed between the edges of floating lid 120 and side walls 106 is reduced. A cover 118 can also be positioned on main body 104 to cover at least a portion of the plurality of wells, and all of the plurality of wells in some implementations.

A top surface 124 of floating lid 120 can have a convex arcuate surface. This allows reagent 114 to be added to well 112 with floating lid 120 already positioned in well 112. As reagent is added to well 112, reagent will run off of the convex top surface 124 of floating lid 120 towards a circumference 122 and will pass through the gap formed between circumference 122 and side walls 106 in into well 112. The circumference 122 may be referred to as a perimeter, external boundary and/or an exterior surface. The circumference 122 may have any contour including one or more straight surfaces and/or one or more curved surfaces and/or may form any shape having any number of sides. Reagent may additionally or alternatively be added to the well 112 from the opening 110.

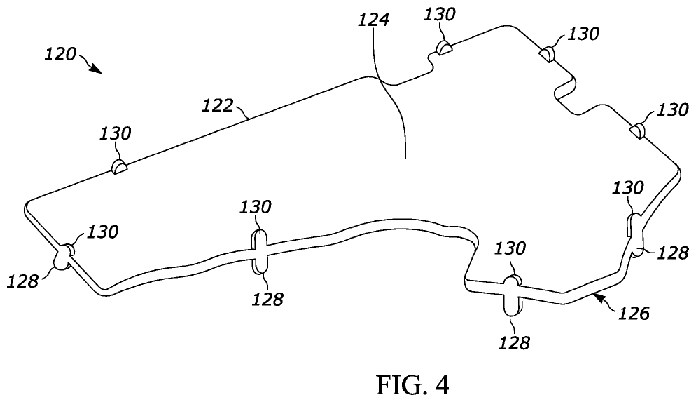

As best seen in FIG. 4, floating lid 120 can have a first plurality of protrusions 128 that are located at positions around circumference 122 and extend downward from a bottom surface 126 of floating lid 120. First plurality of protrusions 128 can be used to keep floating lid 120 from tilting, and therefore possibly getting stuck within well 112, and can keep floating lid 120 from contacting and possibly getting stuck on end wall 108 when the level of reagent 114 is low. The protrusions 128 may engage the end wall 108 and space the floating lid 120 from the opening 110 and deter the floating lid 120 from inhibiting fluid flow through the opening 112. Floating lid 120 can also include a second plurality of protrusions 130, which can be located at the same positions around circumference 122 as first plurality of protrusions 128 axially aligned with first plurality of protrusions 128 or at other positions around circumference 122 and extend upward from top surface 124 of floating lid 120, opposite first plurality of protrusions 128. Second plurality of protrusions 130, either individually or with first plurality of protrusions 128, can also keep floating lid 120 from tilting and possibly getting stuck within well 112. Eight pairs of protrusions 128, 130 are arranged to engage and/or interact with different portions and/or surfaces of the well 112. Any other number of protrusions 128 and/or 130 may alternatively be included based on the shape of the well 112, for example. Alternatively, rather than individual protrusions, first plurality of protrusions 128 and/or second plurality of protrusions 130 can be a circumferential wall that extends from top surface 124 and/or bottom surface 126 of floating lid 120, respectively.

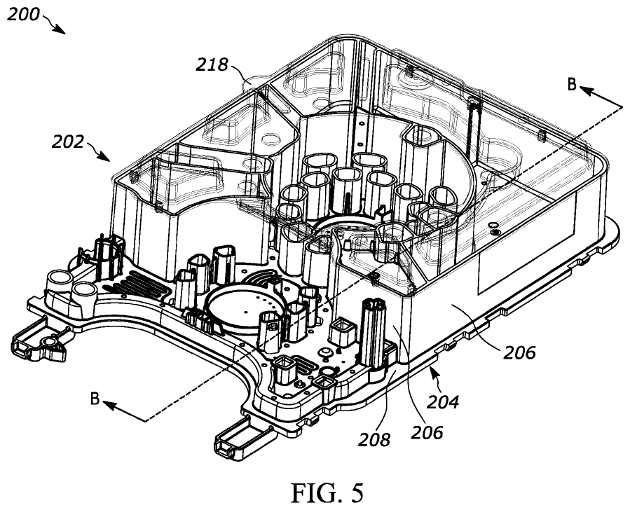

FIGS. 5-7 illustrate a second implementation of an apparatus 200 that can be used for reducing oxidation of reagents in a reagent cartridge. In this implementation, apparatus 200 includes a reagent cartridge 202 having a main body 204 with an end wall 208, or bottom, and a plurality of side walls 206 extending from end wall 208. Side walls 206 and end wall 208 of main body 204 can form a well 212, or a plurality of wells, depending on the design and use of reagent cartridge 202. A reagent 214 can be disposed in well 212 and an opening 210 can be formed in end wall 208, in fluid communication with well 212, and extend through end wall 208 and into well 212 to extract reagent 214 from well 212 during operation. A floating lid 220 can also be disposed in well 212 on a top surface 216 of reagent 214 to reduce oxidation of reagent 214 and, in some instances, assist in temperature control of reagent 214. The floating lid 220 is similar to the floating lid 120 of FIG. 1. The floating lid 220 has a different shape corresponding to the well 212 and includes a guide aperture 232 as further disclosed below.

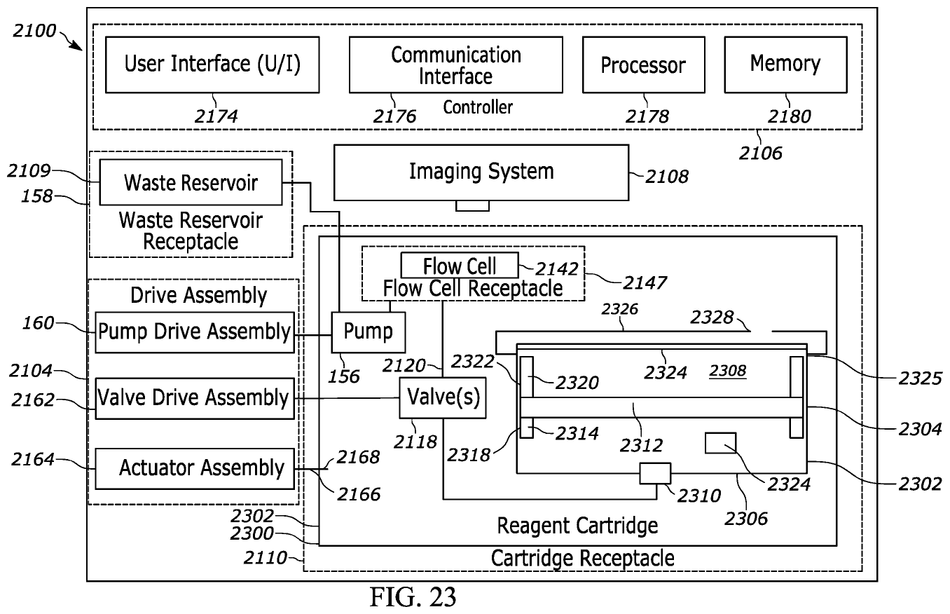

Floating lid 220 can be made of any suitable material, such as polypropylene, such that floating lid 220 will float on top surface 216 of reagent 214, cover a majority of top surface 216 of reagent 214, and the gap formed between the edges of floating lid 220 and side walls 206 is minimized. A cover 218 can also be positioned on main body 204 to cover at least a portion of the plurality of wells, and all of the plurality of wells in some implementations. The cover 218 defines holes that allow a piercer of an associated instrument such as the system 2100 of FIG. 23 to pierce a liquid impermeable barrier.

A top surface 224 of floating lid 220 can have a convex arcuate surface. This allows reagent 214 to be added to well 212 with floating lid 220 already positioned in well 212. As reagent is added to well 212, reagent will run off of the convex top surface 224 of floating lid 220 towards a circumference 222 and will pass through the gap formed between circumference 222 and side walls 206 in into well 212.

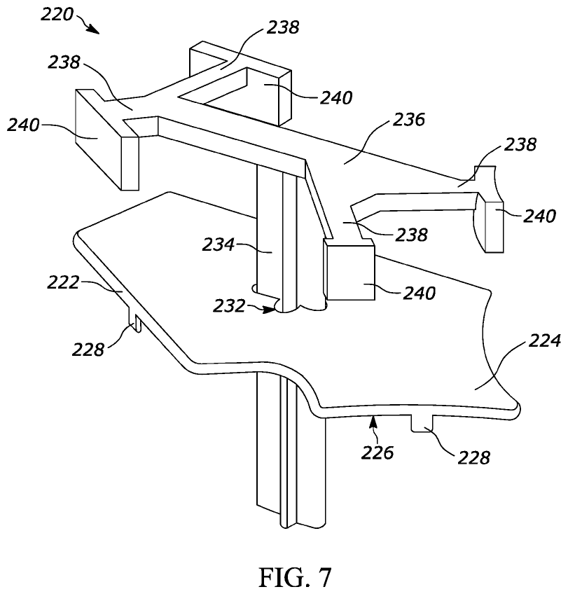

As best seen in FIG. 7, floating lid 220 can have a first plurality of protrusions 228 that are located at positions around circumference 222 and extend downward from a bottom surface 226 of floating lid 220. First plurality of protrusions 228 can be used to keep floating lid 220 from tilting, and therefore possibly getting stuck within well 212, and can keep floating lid 220 from contacting and possibly getting stuck on end wall 208 when the level of reagent 214 is low. Although not shown in this implementation, floating lid 220 can also include a second plurality of protrusions, like second plurality of protrusions 130 described above, which can be located at the same positions around circumference 222 as first plurality of protrusions 228 axially aligned with first plurality of protrusions 228 or at other positions around circumference 222 and extend upward from top surface 224 of floating lid 220, opposite first plurality of protrusions 228. The second plurality of protrusions, either individually or with first plurality of protrusions 228, can also keep floating lid 220 from tilting and possibly getting stuck within well 212. Alternatively, rather than individual protrusions, first plurality of protrusions 228 and/or the second plurality of protrusions can be a circumferential wall that extends from top surface 224 and/or bottom surface 226 of floating lid 220, respectively.

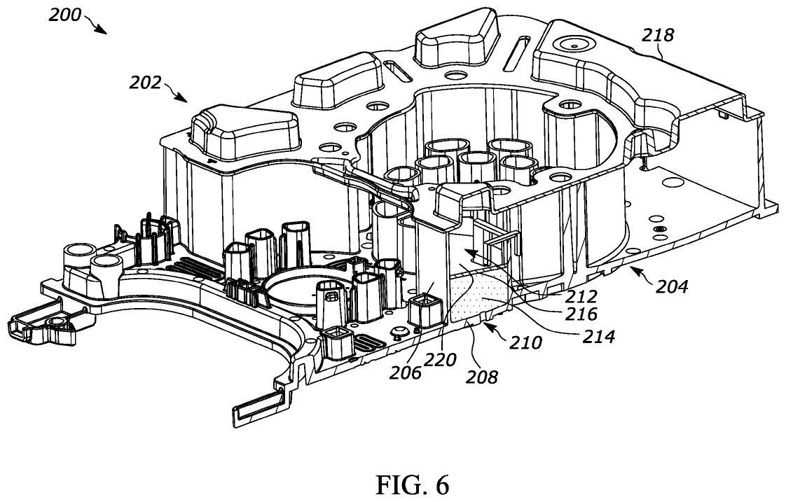

Apparatus 200 can also include a guide structure to guide floating lid 220 in a vertical manner and assist in preventing floating lid 220 from tilting. Referring to FIGS. 6 and 7, apparatus 200 can also include a post 234 that is configured to be positioned in well 212 generally parallel to side walls 206. Post 234 has an outer shape (“cross” or “plus” shaped as shown) and floating lid 220 has a guide aperture 232 that has a shape that is generally the same, but slightly larger, that the outer shape of post 234. Post 234 extends through guide aperture 232 in floating lid 220 and post 234 can assist in guiding floating lid 220 in a vertical direction with floating lid 220 disposed in well 212. In addition, to keep post 234 in a vertical position and parallel to side walls 206, a support 236 can be positioned at or near an end of post 234 and have legs 238 that extend outward from post 234 towards and to respective side walls 206. As shown in FIGS. 5-7, support 236 has four legs 238, but can have any number of legs 238 desired for a particular application and a particular well shape. Typically, at least two legs 238 directed in generally opposing directions should be used to provide support for post 234. Each leg 238 can also have a support foot 240 disposed at an end of leg 238 that extends generally perpendicular to leg 238 and generally parallel to the respective side wall 206 to assist in supporting post 234 and support 236 between side walls 206 within well 212. As shown, post 234 and support 236 may be an integral, one-piece unit in some implementations, but may also be two separate units that are secured, connected, or attached together.

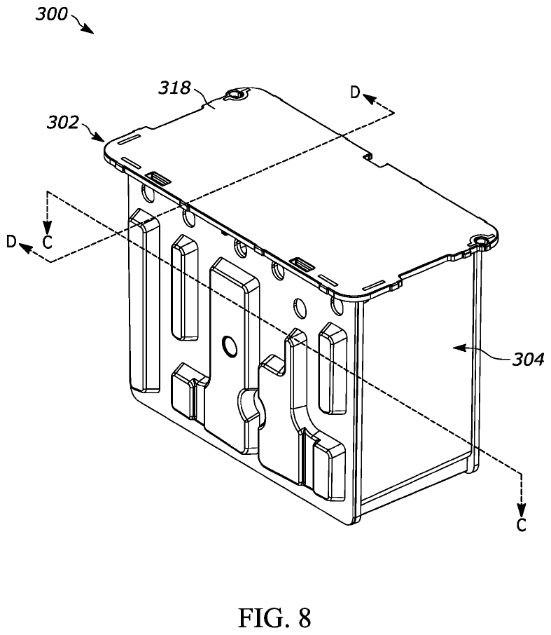

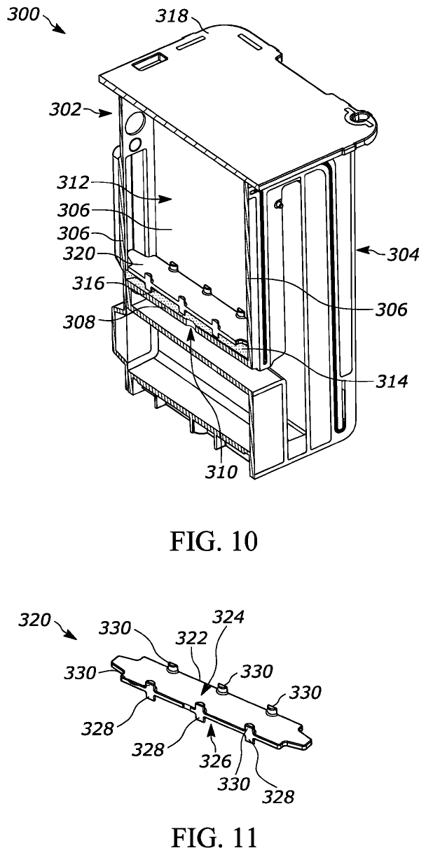

FIGS. 8-11 illustrate a third implementation of an apparatus 300 that can be used for reducing oxidation of reagents in a reagent cartridge. In this implementation, apparatus 300 includes a reagent cartridge 302 having a main body 304 with an end wall 308, or bottom, and a plurality of side walls 306 extending from end wall 308. The reagent cartridge 302 may be configured to be pressurized to allow reagent contained within the reagent cartridge 302 to be urged out of the reagent cartridge 302 under positive pressure. Side walls 306 and end wall 308 of main body 304 can form a well 312, or a plurality of wells, depending on the design and use of reagent cartridge 302. A reagent 314 can be disposed in well 312 and an opening 310 can be formed in end wall 308, in fluid communication with well 312, and extend through end wall 308 and into well 312 to extract reagent 314 from well 312 during operation. A floating lid 320 can also be disposed in well 312 on a top surface 316 of reagent 314 to reduce oxidation of reagent 314 and, in some instances, assist in temperature control of reagent 314.

Floating lid 320 can be made of any suitable material, such as polypropylene, such that floating lid 320 will float on top surface 316 of reagent 314, cover a majority of top surface 316 of reagent 314, and the gap formed between the edges of floating lid 320 and side walls 306 is minimized. A cover 318 can also be positioned on main body 304 to cover at least a portion of the plurality of wells, and all of the plurality of wells in some implementations.

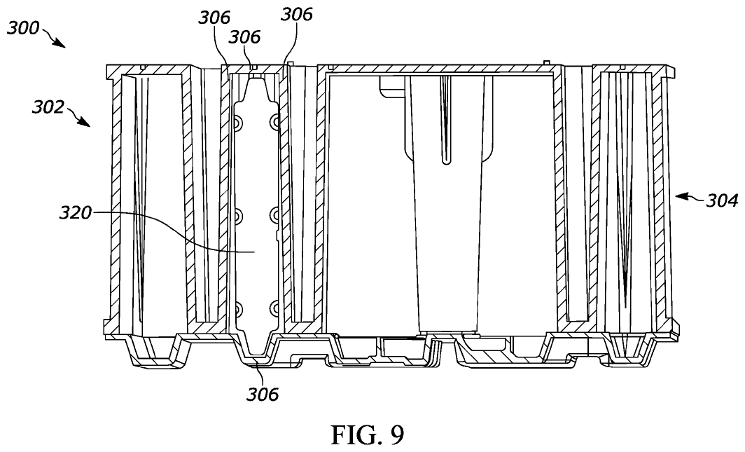

A top surface 324 of floating lid 320 can have a convex arcuate surface. This allows reagent 314 to be added to well 312 with floating lid 320 already positioned in well 312. As reagent is added to well 312, reagent will run off of the convex top surface 324 of floating lid 320 towards a circumference 322 and will pass through the gap formed between circumference 322 and side walls 306 in into well 312. In addition, floating lid 320 can have any circumferential shape desired to fit within a given well. For example, as shown in FIGS. 9-11, floating lid 320 has generally parallel linear sides and tapered ends to fit within well 312.

As best seen in FIG. 11, floating lid 320 can have a first plurality of protrusions 328 that are located at positions around circumference 322 and extend downward from a bottom surface 326 of floating lid 320. First plurality of protrusions 328 can be used to keep floating lid 320 from tilting, and therefore possibly getting stuck within well 312, and can keep floating lid 320 from contacting and possibly getting stuck on end wall 308 when the level of reagent 314 is low. Floating lid 320 can also include a second plurality of protrusions 330, which can be located at the same positions around circumference 322 as first plurality of protrusions 328 axially aligned with first plurality of protrusions 328 or at other positions around circumference 322 and extend upward from top surface 324 of floating lid 320, opposite first plurality of protrusions 328. Second plurality of protrusions 330, either individually or with first plurality of protrusions 328, can also keep floating lid 320 from tilting and possibly getting stuck within well 312. Alternatively, rather than individual protrusions, first plurality of protrusions 328 and/or second plurality of protrusions 330 can be a circumferential wall that extends from top surface 324 and/or bottom surface 326 of floating lid 320, respectively.

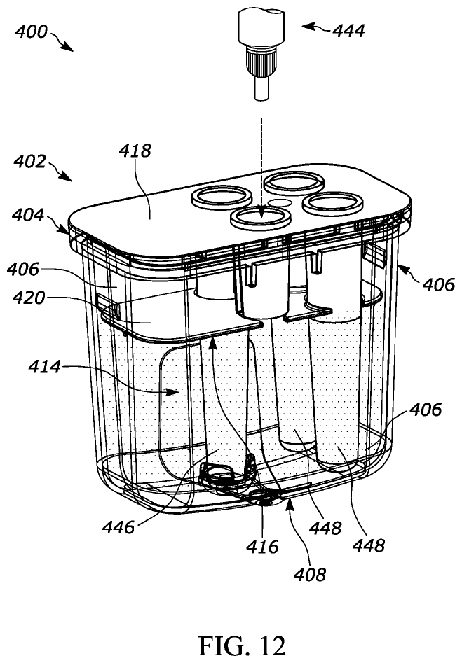

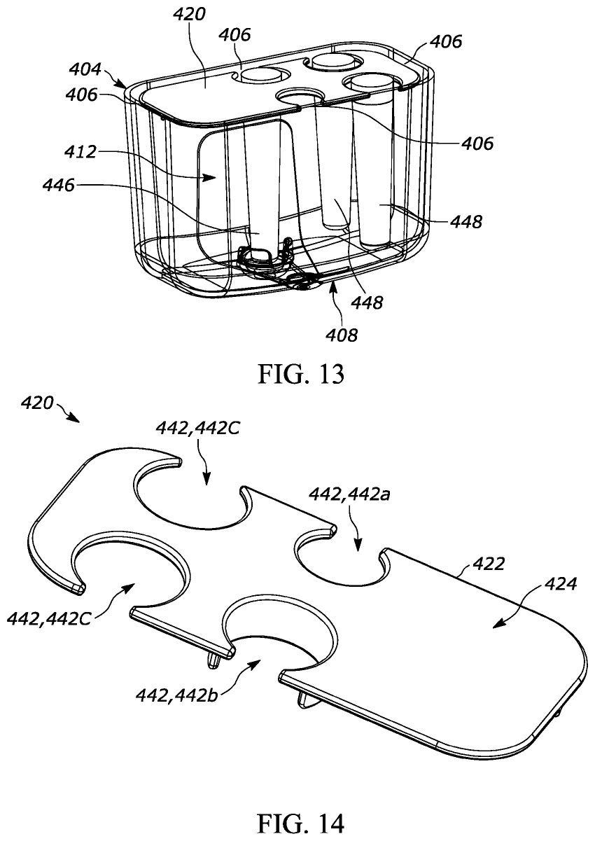

FIGS. 12-15 illustrate a fourth implementation of an apparatus 400 that can be used for reducing oxidation of reagents in a reagent cartridge. In this implementation, apparatus 400 includes a reagent cartridge 402 having a main body 404 with an end wall 408, or bottom, and a plurality of side walls 406 extending from end wall 408. Side walls 406 and end wall 408 of main body 404 can form a well 412, or a plurality of wells, depending on the design and use of reagent cartridge 402. A reagent 414 can be disposed in well 412. A floating lid 420 can also be disposed in well 412 on a top surface 416 of reagent 414 to reduce oxidation of reagent 414 and, in some instances, assist in temperature control of reagent 414.

Floating lid 420 can be made of any suitable material, such as polypropylene, such that floating lid 420 will float on top surface 416 of reagent 414, cover a majority of top surface 416 of reagent 414, and the gap formed between the edges of floating lid 420 and side walls 406 is minimized. A cover 418 can also be positioned on main body 404 to cover well 412 or at least a portion of the plurality of wells, and all of the plurality of wells in some implementations, if there are a plurality of wells.

A top surface 424 of floating lid 420 can have a convex arcuate surface. This allows reagent 414 to be added to well 412 with floating lid 420 already positioned in well 412. As reagent 414 is added to well 412, reagent 414 will run off of the convex top surface 424 of floating lid 420 towards a circumference 422 and will pass through the gap formed between circumference 422 and side walls 406 in into well 412.

Although not shown in the particular implementation of FIGS. 12-15, floating lid 420 can have a first plurality of protrusions, similar to first plurality of protrusions 128, that are located at positions around circumference 422 and extend downward from a bottom surface 426 of floating lid 420. The first plurality of protrusions can be used to keep floating lid 420 from tilting, and therefore possibly getting stuck within well 412, and can keep floating lid 420 from contacting and possibly getting stuck on end wall 408 when the level of reagent 414 is low. Floating lid 420 can also include a second plurality of protrusions, similar to second plurality of protrusions 130, which can be located at the same positions around circumference 422 as the first plurality of protrusions, axially aligned with the first plurality of protrusions or at other positions around circumference 422, and extend upward from top surface 424 of floating lid 420, opposite the first plurality of protrusions. The second plurality of protrusions, either individually or with the first plurality of protrusions, can also keep floating lid 420 from tilting and possibly getting stuck within well 412. Alternatively, rather than individual protrusions, the first plurality of protrusions and/or the second plurality of protrusions can be a circumferential wall that extends from top surface 424 and/or bottom surface 426 of floating lid 420, respectively.

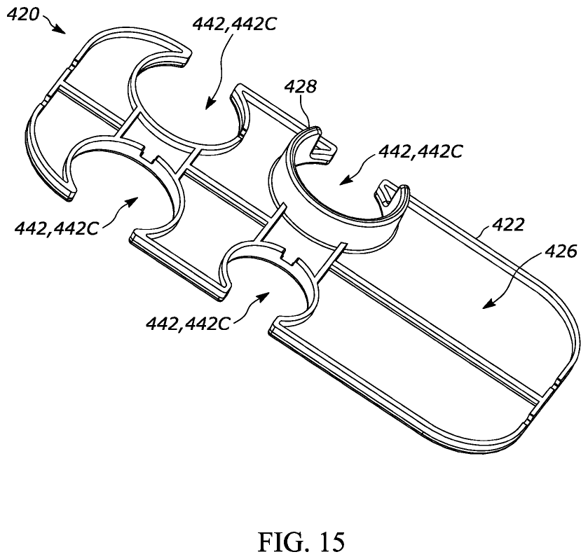

Floating lid 420 can also include at least one aperture 442 formed through floating lid 420 that can be configured to receive additional structure, such as sippers, wash tubes, and/or additional reagent containers. For example, as shown in FIGS. 12-15, floating lid 420 includes a first aperture 442a that is configured to receive a sipper 444 therethrough, a second aperture 442b that is configured to receive a wash tube 446 therethrough, and a third aperture 442c that is configured to receive an additional reagent container 448 therethrough. As shown in FIG. 15, floating lid 420 can also have a cylindrical, or partially cylindrical, wall 428 that surrounds, or at least partially surrounds, at least one of the apertures 442 and extends downward from a bottom surface 426 of floating lid 420. Wall 428 can be used to keep floating lid 420 from tilting, and therefore possibly getting stuck within well 412, and to keep floating lid 420 from contacting and possibly getting stuck on end wall 408 when the level of reagent 414 is low.

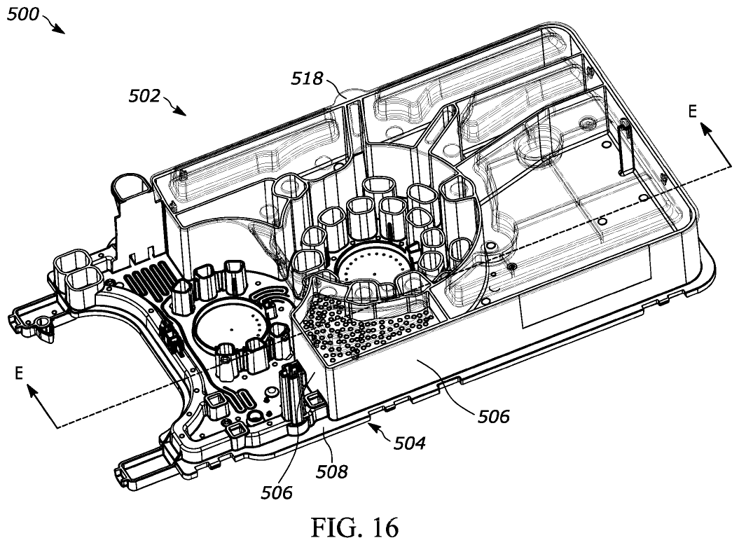

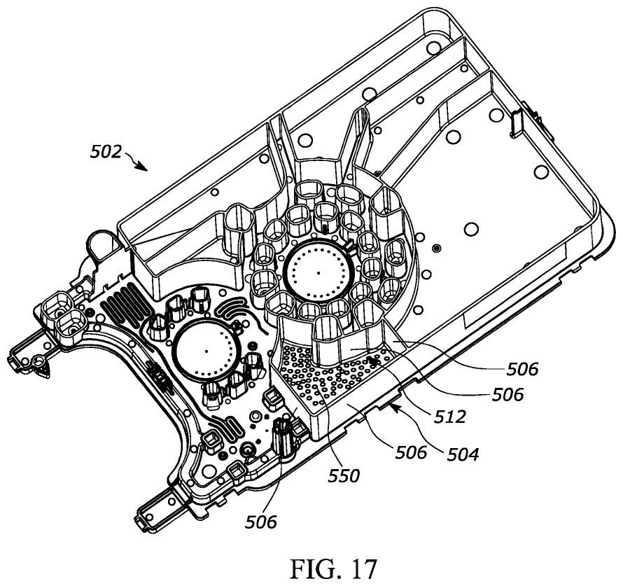

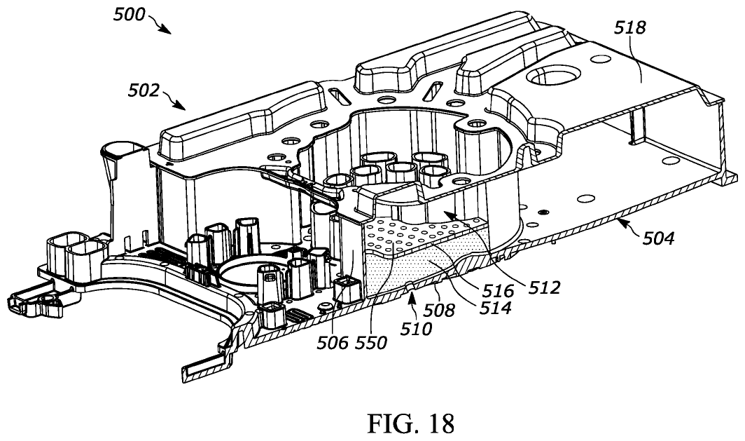

FIGS. 16-18 illustrate a fifth implementation of an apparatus 500 that can be used for reducing oxidation of reagents in a reagent cartridge. Similar to apparatus 100, in this implementation, apparatus 500 includes a reagent cartridge 502 having a main body 504 with an end wall 508, or bottom, and a plurality of side walls 506 extending from end wall 508. Side walls 506 and end wall 508 of main body 504 can form a well 512, or a plurality of wells, depending on the design and use of reagent cartridge 502. A reagent 514 can be disposed in well 512 and an opening 510 can be formed in end wall 508, in fluid communication with well 512, and extend through end wall 508 and into well 512 to extract reagent 514 from well 512 during operation. A plurality of pellets, plastic pellets 550, can also be disposed in well 512 on a top surface 516 of reagent 514 to reduce oxidation of reagent 514. In some implementations, the pellets 550 may be made of any suitable material, for example, any material compatible with and having a density less than the reagent. One or more layers of plastic pellets 550 float on top surface 516 of reagent 513 and cover a majority of top surface 516 of reagent 514 and each has at least one of a cuboid shape, an ovoid shape, a cylindrical shape, or a spheroid shape. The use of plastic pellets 550 can provide an oxygen barrier efficacy of approximately 65-80% and creates minimal compatibility risks with reagent 514. Plastic pellets 550 may be made of Braskem HDPE, but can alternatively be made of any appropriate material, such as Bormed LDPE, Marlex HDPE, DT3300 PP, or Profax PD702 PP. Thus the pellets 550 may not be made of plastic in some implementations. In addition, to provide sufficient coverage of top surface 516 of reagent 512 and reduce the volume of passages between each plastic pellet, plastic pellets 550 may each have a maximum axial length of between approximately 3.0 mm to approximately 4.0 mm. If appropriate for a given application, micro-pellets can also be used, in which case, plastic pellets 550 would each have a maximum axial length of less than about 1.5 mm. Micro-pellets occupy much less headspace volume and can provide higher surface coverage percentage of reagent 514 (due to reduced gaps between pellets). A cover 518 can also be positioned on main body 504 to cover at least a portion of the plurality of wells, and all of the plurality of wells in some implementations.

To avoid contamination of reagent 514, plastic pellets 550 should be cleaned before being placed in well 512. This can be done via deionization, washing (e.g., using fluid agitation to dislodge and filter out contaminants, ultrasonic washing using, for example, a Jayco Ultrasonic Cleaner, ultrasonic agitation, continuous filtering of solvent with particulates using 5 um filter, etc.), de-dusting and washing (e.g., using a Pelletron De-Duster), etc.

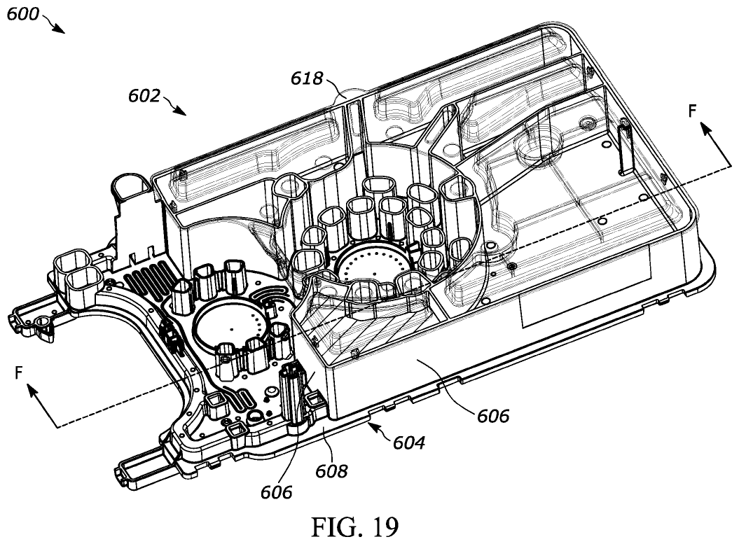

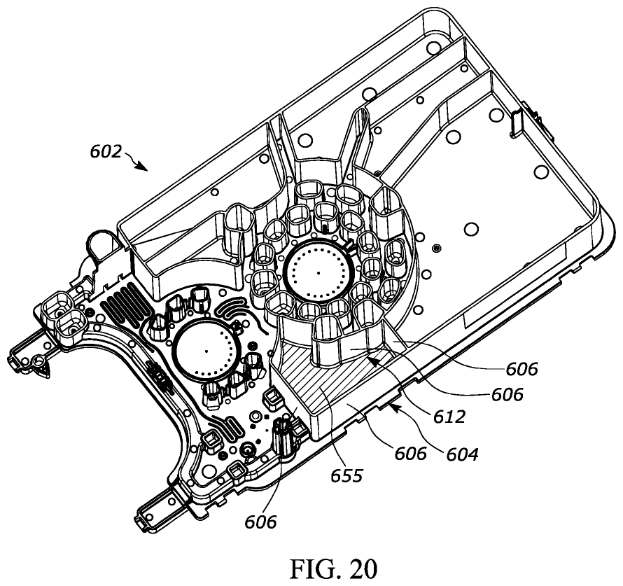

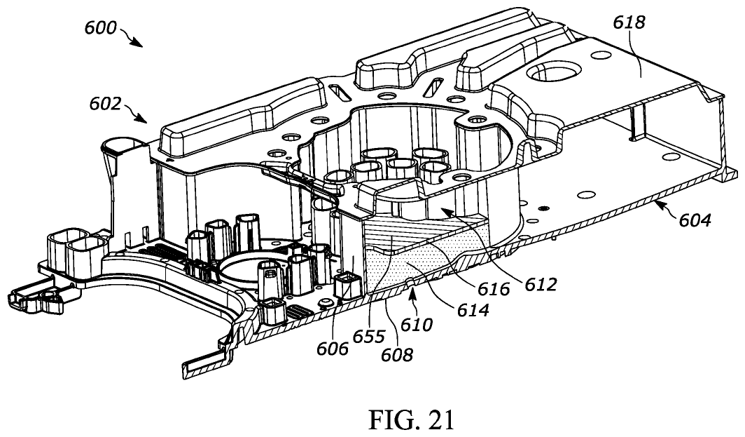

FIGS. 19-21 illustrate a sixth implementation of an apparatus 600 that can be used for reducing oxidation of reagents in a reagent cartridge. Similar to apparatus 100, in this implementation, apparatus 600 includes a reagent cartridge 602 having a main body 604 with an end wall 608, or bottom, and a plurality of side walls 606 extending from end wall 608. Side walls 606 and end wall 608 of main body 604 can form a well 612, or a plurality of wells, depending on the design and use of reagent cartridge 602. A reagent 614 can be disposed in well 612 and an opening 610 can be formed in end wall 608, in fluid communication with well 612, and extend through end wall 608 and into well 612 to extract reagent 614 from well 612 during operation. An oil 655 can also be disposed in well 612 on a top surface 616 of reagent 614 to reduce oxidation of reagent 614. Oil 655 can be one of a mineral oil or a silicone oil, or any other type of oil that can provide an oxygen barrier and that will not react with reagent 614. The use of oil 655 on top surface 616 of reagent 614 can provide an oxygen barrier efficacy greater than 85% and only uses a small extra headspace volume for oil 655. A cover 618 can also be positioned on main body 604 to cover at least a portion of the plurality of wells, and all of the plurality of wells in some implementations.

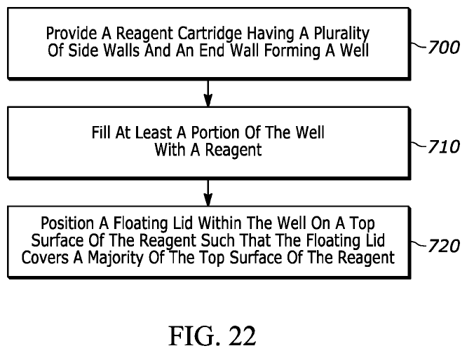

Referring to FIG. 22, a first implementation of a method for reducing the oxidation of a reagent, using the apparatus shown in FIGS. 1-15 and described above, is illustrated. In this implementation, at Block 700, a reagent cartridge is provided that includes an end wall, or bottom, and a plurality of side walls that extend from the end wall. The end wall and the plurality of side walls forming a well. At least a portion of the well is filled with a reagent at Block 710. At Block 720, a floating lid is positioned within the well on a top surface of the reagent such that the floating lid floats on the top surface of the reagent and covers a majority of the top surface of the reagent.

In some implementations, a top surface of the floating lid can be convex to allow reagent added to the well after the floating lid is positioned in the well to flow off of the floating lid, between a gap formed by the edges of the floating lid and the side walls, and into the well. In these implementations, the floating lid can be positioned within the well prior to the well being filled with the reagent.

In other implementations, the floating lid can have a first plurality of protrusions located at positions around a circumference of the floating lid and extending from a bottom surface of the floating lid to keep the floating lid from tipping and getting stuck in the well and to keep the floating lid off the end wall when the level of the reagent is low. If appropriate, the floating lid can also have a second plurality of protrusions, possibly axially aligned with the first plurality of protrusions, that are located at positions around the circumference of the floating lid and extend from the top surface of the floating lid.

In other implementations, the floating lid can have at least one aperture, and possibly multiple apertures, formed through the floating lid that are configured to receive at least one of a sipper, a wash tube, and/or an additional reagent container.

In other implementations, a post can be positioned with the well, generally parallel to the side wall. The post can have an outer shape and a guide aperture in the floating lid can have a shape that is substantially the same, but slightly larger than, the outer shape of the post. The floating lid can them be positioned within the well such that the post extends through the guide aperture in the floating lid. The post can also include a support, forming an integral, one-piece unit with the post in some implementations, that is positioned at or near an end of the post. The support can have at least two, or more, legs that extend away from the post and towards and to respective side walls to support the post within the well.

FIG. 23 illustrates a schematic diagram of an implementation of a system 2100 in accordance with the teachings of this disclosure. The system 2100 can be used to perform an analysis on one or more samples of interest, such as nucleic acid sequencing. The sample may include one or more DNA clusters that have been linearized to form a single stranded DNA (sstDNA). In the implementation shown, the system 2100 receives a reagent cartridge 2102 and includes, in part a drive assembly 2104, a controller 2106, an imaging system 2108, and a waste reservoir 2109. The reagent cartridge 2102 may be implemented by any one of the reagent cartridges 102, 202, 502 of FIGS. 1, 5, and 16. In other implementations, the reagent cartridge 2202 may be implemented by any one of reagent cartridges 302, 402 of FIGS. 8, 12. The reagent cartridge 2102 may be implemented in different ways, however.

The controller 2106 is electrically and/or communicatively coupled to the drive assembly 2104 and to the imaging system 2108 and causes the drive assembly 2104 and/or the imaging system 2108 to perform various functions as disclosed herein. The system 2100 may include a sipper assembly including sippers that draw reagent from the reagent cartridge 2101 in alternative implementations. The system 2100 may include the sipper assembly when used with the reagent cartridge 402 of FIG. 12, for example. The system 2100 may additionally or alternatively include a gas source and a regulator that can pressurize the reagent cartridge 2102 and urge reagent out of the reagent cartridge 2102 using positive pressure.

The reagent cartridge 2102 carries the sample of interest and may be referred to a consumable. The drive assembly 2104 may interface with the reagent cartridge 2102 to rehydrate dry reagents and/or flow one or more liquid reagents (e.g., A, T, G, C nucleotides) through the reagent cartridge 2102 that interact with the sample.

In an implementation, a reversible terminator is attached to the reagent to allow a single nucleotide to be incorporated by the sstDNA per cycle. In some such implementations, one or more of the nucleotides has a unique fluorescent label that emits a color when excited. The color (or absence thereof) is used to detect the corresponding nucleotide. In the implementation shown, the imaging system 2108 excites one or more of the identifiable labels (e.g., a fluorescent label) and thereafter obtains image data for the identifiable labels. The labels may be excited by incident light and/or a laser and the image data may include one or more colors emitted by the respective labels in response to the excitation. The image data (e.g., detection data) may be analyzed by the system 2100. The imaging system 2108 may be a fluorescence spectrophotometer including an objective lens and/or a solid-state imaging device. The solid-state imaging device may include a charge coupled device (CCD) and/or a complementary metal oxide semiconductor (CMOS).

After the image data is obtained, the drive assembly 2104 interfaces with the reagent cartridge 2102 to flow another reaction component (e.g., a reagent) that is thereafter received by the waste reservoir 2109 and/or otherwise exhausted by the reagent cartridge 2102. The sstDNA is then ready for another cycle.

Referring to the reagent cartridge 2102, in the implementation shown, the reagent cartridge 2102 is receivable within a cartridge receptacle 2110 of the system 2100 and includes a reagent reservoir 2300, a body 2302, one or more valves 2118, and fluidic lines 2120. The valves 2118 may be selectively actuatable to control the flow of fluid through the fluidic lines 2120. One or more of the valves 2118 may be implemented by a rotary valve, a pinch valve, a flat valve, a solenoid valve, a check valve, a piezo valve, etc. The body 2302 may be formed of solid plastic using injection molding techniques and/or additive manufacturing techniques. In some implementations, the reagent reservoirs 2114 are integrally formed with the body 2302. In other implementations, the reagent reservoirs 2114 are separately formed and coupled to the body 2302. The reagent reservoirs 2114 and/or the reagent cartridge 2102 may include polypropylene and/or cyclic olefin copolymer (COC) with an over molded Santoprene thermoplastic elastomer (TPE) or another thermoplastic elastomer. Other materials may prove suitable for the reagent reservoirs 2114 and/or the reagent cartridge 2102.

The reagent cartridge 2102 is in fluid communication with the flow cell 2142. In the implementation shown, a flow cell 2142 is carried by the reagent cartridge 2102 and is received via a flow cell receptacle 2147. As used herein, a “flow cell” can include a device having a lid extending over a reaction structure to form a flow channel therebetween that is in communication with a plurality of reaction sites of the reaction structure, and can include a detection device that detects designated reactions that occur at or proximate to the reaction sites. Alternatively, the flow cell 2142 can be integrated into the reagent cartridge 2102. In such implementations, the flow cell receptacle 2147 may not be included or, at least, the flow cell 2142 may not be removably receivable within the reagent cartridge 2102. As a further alternative, the flow cell 2142 may be separate from the reagent cartridge 2102.

The reagent cartridge 2102 may include a pump 2156 positioned between the flow cell 2142 and the waste reservoir 2109. The waste reservoir 2109 may be selectively receivable within a waste reservoir receptacle 2158 of the system 2100. The pump 2156 may be implemented by a syringe pump, a peristaltic pump, a diaphragm pump, etc. While the pump 2156 may be positioned between the flow cell 2142 and the waste reservoir 2109, in other implementations, the pump 2156 may be positioned upstream of the flow cell 2142 or omitted entirely.

The reagent cartridge 2102 includes the body 2302 including side walls 2304 and a bottom surface 2306 that form a reagent reservoir 2308. The reagent reservoir 2308 may be referred to as a well. The bottom surface 2306 includes a port 2310. The reagent cartridge 2300 also includes a lid 2312 movably disposed in the reagent reservoir 2308 in the implementation shown. The lid 2312 may be referred to as a floating lid or a cover. The lid 2312 includes protrusions 2314 that extend toward the bottom surface 2306. The protrusions 2314 may engage the bottom surface 2306 to deter the lid 2312 from inhibiting fluid flow through the port 2310.

Each of the protrusions 2314 has an exterior facing surface 2318 that engage or interact with the side walls 2304. The exterior facing surface 2318 of the protrusions 2314 may correspond to the side walls 2304. The exterior facing surface 2318 of the protrusions 2314 may have flat portions and/or have a contour that corresponds to the side walls 2304, for example.

The lid 2312 also includes second protrusions 2320 that extend away from the bottom surface 2306 in the implementation shown. The second protrusions 2320 have corresponding exterior facing surfaces 2322 that engage the side walls 2304. The second protrusions 2320 may interact with the exterior facing walls to deter the lid 2312 from rotating within the reagent reservoir 2308. The protrusions 2314 may also deter the lid 2312 from rotating within the well. A length of the protrusions 2314 is shown being less than a length of the second protrusions 2320 in the implementation shown. A length of the protrusions 2314 and the second protrusions 2320 may be similar or the same as shown in other implementations disclosed or the protrusions 2314 may be longer than the second protrusions 2320. The protrusions 2314 and/or the second protrusions 2320 can be vertical or slightly tapered inward and/or may include rounded or filleted edges. One or more of the protrusions 2314 or the second protrusions 2320 may have a semi-circular cross section. The protrusions 2314 and/or the second protrusions 2320 may have any cross-section, however. Alternatively, the second protrusions 2320 may be omitted.

The reagent cartridge 2300 is shown including reagent 2324 disposed in the reagent reservoir 2308. The reagent 2324 may be liquid reagent and/or dried reagent. The reagent 2324 may alternatively be omitted. The lid 2312 may enable temperature control of reagent 2324 within the reagent reservoir 2308 in some implementations. The lid 2312 may be omitted in other examples and pellets and/or oil may alternatively be used to reduce a rate of oxidation of the reagent 2324.

A liquid impermeable barrier 2324 is shown covering an opening 2325 of the reagent reservoir 2308. The liquid impermeable barrier 2324 may include foil or a thin plastic sheet. For example, the liquid impermeable barrier 2324 may be implemented by a thin metal foil, such as aluminum foil, or a thin plastic sheet(s), such as Saran™ wrap.

A cover 2326 is shown covering the liquid impermeable barrier 2324 and coupled to the body 2302. The cover 2326 includes an aperture 2328 to allow the liquid impermeable barrier 2324 to be accessed through the aperture 2328.

Referring now to the drive assembly 2104, in the implementation shown, the drive assembly 2104 includes a pump drive assembly 2160, a valve drive assembly 2162, and an actuator assembly 2164. The pump drive assembly 2160 interfaces with the pump 2156 to pump fluid through the reagent cartridge 2102 and the valve drive assembly 2162 interfaces with the valve 2118 to control the position of the valve 2118. The actuator assembly 2164 interfaces with the reagent reservoir 2308 to pierce the liquid impermeable barrier 2324. As an example, the actuator assembly 2164 includes a rod 2166 having a distal end 2168 that passes through the aperture 2328 and pierces the liquid impermeable barrier 2324. The actuator assembly 2164 may include a linear actuator.

Referring to the controller 2106, in the implementation shown, the controller 2106 includes a user interface 2174, a communication interface 2176, one or more processors 2178, and a memory 2180 storing instructions executable by the one or more processors 2178 to perform various functions including the disclosed implementations. The user interface 2174, the communication interface 2176, and the memory 2180 are electrically and/or communicatively coupled to the one or more processors 2178.

In an implementation, the user interface 2174 receives input from a user and provides information to the user associated with the operation of the system 2100 and/or an analysis taking place. The user interface 2174 may include a touch screen, a display, a key board, a speaker(s), a mouse, a track ball, and/or a voice recognition system. The touch screen and/or the display may display a graphical user interface (GUI).

In an implementation, the communication interface 2176 enables communication between the system 2100 and a remote system(s) (e.g., computers) via a network(s). The network(s) may include an intranet, a local-area network (LAN), a wide-area network (WAN), the intranet, etc. Some of the communications provided to the remote system may be associated with analysis results, imaging data, etc., generated or otherwise obtained by the system 2100. Some of the communications provided to the system 2100 may be associated with a fluidics analysis operation, patient records, and/or a protocol(s) to be executed by the system 2100.

The one or more processors 2178 and/or the system 2100 may include one or more of a processor-based system(s) or a microprocessor-based system(s). In some implementations, the one or more processors 2178 and/or the system 2100 includes a reduced-instruction set computer(s) (RISC), an application specific integrated circuit(s) (ASICs), a field programable gate array(s) (FPGAs), a field programable logic device(s) (FPLD(s)), a logic circuit(s), and/or another logic-based device executing various functions including the ones described herein.

The memory 2180 can include one or more of a hard disk drive, a flash memory, a read-only memory (ROM), erasable programable read-only memory (EPROM), electrically erasable programable read-only memory (EEPROM), a random-access memory (RAM), non-volatile RAM (NVRAM) memory, a compact disk (CD), a digital versatile disk (DVD), a cache, and/or any other storage device or storage disk in which information is stored for any duration (e.g., permanently, temporarily. for extended periods of time, for buffering, for caching).

Using any of the apparatus described above (e.g., apparatus 100, 200, 300, or 400), a method of nucleic acid sequencing can be performed that allows the reagent to at least substantially retain its chemistry, and therefore the apparatus to be utilized, for a longer time. For example, using apparatus 100, 200, 300, or 400, a first portion of the reagent can be withdrawn from the well at a first time and a second portion of the reagent can be withdrawn from the well at a second time, at least 36 hours after the first time, with little or no substantive reduction in the activity of the reagent chemistry due to oxidation of the reagent. In some implementations, the second time can be at least 10 days after the first time or, in other implementations, the second time can be at least 15 days after the first time.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

As used herein, an element or step recited in the singular and proceeded with the word “a” or “an” should be understood as not excluding plural of said elements or steps, unless such exclusion is explicitly stated. Furthermore, references to “one implementation” are not intended to be interpreted as excluding the existence of additional implementations that also incorporate the recited features. Moreover, unless explicitly stated to the contrary, implementations “comprising,” “including,” or “having” an element or a plurality of elements having a particular property may include additional elements whether or not they have that property. Moreover, the terms “comprising,” including, “having,” or the like are interchangeably used herein.

The terms “connect,” “connected,” “contact” “coupled” and/or the like are broadly defined herein to encompass a variety of divergent arrangements and assembly techniques. These arrangements and techniques include, but are not limited to (1) the direct joining of one component and another component with no intervening components therebetween (i.e., the components are in direct physical contact); and (2) the joining of one component and another component with one or more components therebetween, provided that the one component being “connected to” or “contacting” or “coupled to” the other component is somehow in operative communication (e.g., electrically, fluidly, physically, optically, etc.) with the other component (notwithstanding the presence of one or more additional components therebetween). It is to be understood that some components that are in direct physical contact with one another may or may not be in electrical contact and/or fluid contact with one another. Moreover, two components that are electrically connected, electrically coupled, optically connected, optically coupled, fluidly connected or fluidly coupled may or may not be in direct physical contact, and one or more other components may be positioned therebetween.

The terms “generally”, “substantially,” “approximately,” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

There may be many other ways to implement the subject technology. Various functions and elements described herein may be partitioned differently from those shown without departing from the scope of the subject technology. Various modifications to these implementations may be readily apparent to those skilled in the art, and generic principles defined herein may be applied to other implementations. Thus, many changes and modifications may be made to the subject technology, by one having ordinary skill in the art, without departing from the scope of the subject technology. For instance, different numbers of a given module or unit may be employed, a different type or types of a given module or unit may be employed, a given module or unit may be added, or a given module or unit may be omitted.

Underlined and/or italicized headings and subheadings are used for convenience only, do not limit the subject technology, and are not referred to in connection with the interpretation of the description of the subject technology. All structural and functional equivalents to the elements of the various implementations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

1. An apparatus, comprising:
a reagent cartridge comprising a well;
a reagent disposed within the well; and
a floating lid disposed in the well on a top surface of the reagent, the floating lid covering a majority of the top surface of the reagent.

2. The apparatus of claim 1, wherein a top surface of the floating lid is convex.

3. The apparatus of claim 1, wherein the floating lid comprises a first plurality of protrusions located at positions around a circumference of the floating lid and extending from a bottom surface of the floating lid.

4. The apparatus of claim 3, wherein the floating lid comprises a second plurality of protrusions located at positions around the circumference of the floating lid and extending from a top surface of the floating lid.

5. The apparatus of claim 4, wherein the first plurality of protrusions are axially aligned with the second plurality of protrusions.

6. The apparatus of claim 1, wherein the floating lid comprises at least one aperture formed through the floating lid and configured to receive at least one of a sipper, a wash tube, and/or an additional reagent container.

7. The apparatus of claim 1, wherein the reagent cartridge comprises a plurality of side walls and an end wall that form the well, the apparatus comprising:
a post having an outer shape, the post configured to be positioned with the well generally parallel to the side walls;
wherein the floating lid includes a guide aperture having a shape generally the same as the outer shape of the post; and
the floating lid is disposed in the well with the post extending through the guide aperture.

8. The apparatus of claim 7, comprising a support positioned at an end of the post, the support having at least two legs extending towards and to respective side walls.

9. The apparatus of claim 8, wherein the post and the support form an integral, one-piece unit.

10-15. (canceled)

16. A reagent cartridge, comprising:
a main body comprising an end wall and a plurality of side walls extending from the end wall, the end wall and the plurality of side walls forming a plurality of wells;
an opening extending through the end wall and into one well of the plurality of wells;
a floating lid disposed in the one well of the plurality of wells; and
a cover positioned on the main body and covering at least a portion of the plurality of wells.

17. The reagent cartridge of claim 16, comprising a reagent disposed within the one well of the plurality of wells, wherein the floating lid is disposed on a top surface of the reagent and covers a majority of the top surface of the reagent.

18. The reagent cartridge of claim 16, wherein a top surface of the floating lid is convex.

19. The reagent cartridge of claim 16, wherein the floating lid comprises a first plurality of protrusions located at positions around a circumference of the floating lid and extending from a bottom surface of the floating lid.

20. The reagent cartridge of claim 19, wherein the floating lid comprises a second plurality of protrusions located at positions around the circumference of the floating lid and extending from a top surface of the floating lid.

21. The reagent cartridge of claim 20, wherein the first plurality of protrusions are axially aligned with the second plurality of protrusions.

22. The reagent cartridge of claim 16, comprising:
a post having an outer shape, the post configured to be positioned with the one well of the plurality of wells generally parallel to the side walls;
wherein the floating lid includes a guide aperture having a shape generally the same as the outer shape of the post; and
the floating lid is disposed in the well with the post extending through the guide aperture.

23. The reagent cartridge of claim 22, comprising a support positioned at an end of the post, the support having at least two legs extending towards and to respective side walls.

24. The reagent cartridge of claim 23, wherein the post and the support form an integral, one-piece unit.

25-33. (canceled)

34. An apparatus, comprising:
a body, comprising;
a plurality of side walls and a bottom surface that form a reagent reservoir, wherein the bottom surface comprises a port; and
a lid movably disposed in the reagent reservoir and comprising protrusions that extend toward the bottom surface,
wherein the protrusions are to engage the bottom surface to deter the lid from inhibiting fluid flow through the port.

35. The apparatus of claim 34, further comprising reagent disposed in the reagent reservoir.

36. The apparatus of claim 34, wherein the reagent comprises liquid reagent.

37. The apparatus of claim 34, wherein the reagent reservoir has an opening, further comprising a liquid impermeable barrier covering the opening of the reagent reservoir.

38-55. (canceled)
